(19) United States
(12) Patent Application Publication
(10) Pub. No.: US 2024/0111089 A1
(43) Pub. Date: Apr. 4, 2024

(54) NANOROD COATING BETWEEN TWO OPTICAL MEDIUMS

(71) Applicant: Intel Corporation, Santa Clara, CA (US)

(72) Inventors: Yi YANG, Gilbert, AZ (US); Suddhasattwa NAD, Chandler, AZ (US); Robert Alan MAY, Chandler, AZ (US)

(21) Appl. No.: 17/956,750

(22) Filed: Sep. 29, 2022

(51) Int. Cl. G02B 6/12; B82Y 20/00; G02B 1/115; G02B 6/122; G02B 6/132; G02B 6/136; G02B 6/43

(52) U.S. Cl. CPC G02B 6/12004; B82Y 20/00; G02B 1/115; G02B 6/1228; G02B 6/132; G02B 6/136; G02B 6/43; G02B 2006/12038; G02B 2006/12061; G02B 2006/12097; G02B 2006/12147; G02B 2006/12176

(57) ABSTRACT

Embodiments herein relate to systems, apparatuses, techniques, or processes for improving the refractive index of the coating that optically couples with an optical medium, wherein the coating includes one or more layers that include a plurality of nanorods. The plurality of nanorods within each of the one or more layers may have a similar orientation in the chemical composition. The nanorods within separate layers may have different characteristics, including different orientations, different sizes, and/or different chemical compositions. Other embodiments may be described and/or claimed.

### FIELD

Embodiments of the present disclosure generally relate to the field of package assemblies, and in particular package assemblies that include photonics circuitry.

### BACKGROUND

Continued reduction in end product size of mobile electronic devices such as smart phones and ultrabooks is a driving force for the development of reduced size system in package components that include photonics circuitry. Increasing the quality of photonics connections between circuit devices will increase performance and reduce overall package costs.

### BRIEF DESCRIPTION OF THE DRAWINGS

FIGS. 1A-1B illustrates cross section side views of portions of legacy photonics packages that include underfill separating two different optical mediums within an optical path.

FIG. 2 illustrates a cross section side view and a top-down view of a portion of a photonics package that includes a nanorod coating between two different optical mediums within an optical path, in accordance with various embodiments.

FIG. 3 illustrates the cross section side view of layers of a nanorod coating between two different optical mediums within an optical path, in accordance with various embodiments.

FIG. 4 illustrates diagrams of oblique-angle deposition (OAD) techniques that may be used to apply one or more nanorod layers of a nanorod coating onto a surface of an optical medium, in accordance with various embodiments.

FIGS. 5A-5G illustrate various cross section side views of nanorod coatings in various stages of manufacture, in accordance with various embodiments.

FIG. 6 shows an image of a cross section side view of a nanorod coating, in accordance with various embodiments.

FIG. 7 illustrates an example of a process for manufacturing a portion of a package that includes depositing a nanorod coating on an optical medium, in accordance with various embodiments.

FIG. 8 schematically illustrates a computing device, in accordance with various embodiments.

### DETAILED DESCRIPTION

Embodiments of the present disclosure may generally relate to systems, apparatus, techniques, and/or processes directed to creating a photonic component, that may be part of a photonics package, that includes an optical medium with a surface that has a coating that includes a plurality of nanorods. An optical medium may be a material through which light and other electromagnetic waves propagate. In embodiments, the coating may be referred to as a graded-index coating or a graded-index coating structure. In embodiments, some of the plurality of nanorods may have a common orientation, or direction, within the coating.

For example, some of the plurality of nanorods within a layer of the coating may be aligned in a particular direction. In embodiments, there may be multiple layers within the coating, each layer containing a plurality of nanorods with a common orientation. The orientation as well as the size of the plurality of nanorods may differ between layers in the coating. In embodiments, a nanorod may include a rod of material with a thickness or diameter on the order of a few nanometers. In some embodiments, a dimension of a nanorod may range from 1 to 100 nm.

In embodiments, the plurality of nanorods within each layer in the coating will cause the coating to have an overall low refractive index (RI), or low “n”, to reduce the reflection budget used as light passes through the optical medium and through the coating. In embodiments, an underfill between the two optical mediums may surround the coating to provide additional mechanical support and stability for the photonic component. Some embodiments, the other optical medium may be air.

In embodiments, the coating may include a plurality of layers, where each of the layers includes a plurality of nanorods, where the plurality of nanorods have a common orientation within the layer. In some embodiments, the plurality of nanorods in adjacent layers may have a similar orientation. In other embodiments, the plurality of nanorods in adjacent layers may have a different orientation.

Optical coupling is an important area of silicon photonic packaging, and can enable robust, high-bandwidth, low-power optical data communication system in an economical way. Because material interfaces are always involved for an optical coupling, the reflection loss at the interfaces often occupies a major part of optical loss. For example, the photonic bandgap width is directly related to the refraction index contrast. As a result, pursuing low-n materials (n close to 1.0) within optical materials may save reflection budget.

In legacy implementations, a layer may be placed between the two optical mediums to lower the RI, for example a layer that includes as silicon dioxide (SiO₂) film. In these legacy implementations, silicon dioxide film typically has an RI of approximately 1.5, which is not well matched with air, and only works at a single wavelength at a normal incidence. In these legacy implementations, the silicon dioxide film may be a single-layer sputtered amorphous film.

In embodiments described herein, the coating may be placed on an optical medium that includes a glass substrate, which may be a glass core within a photonics package. In embodiments, a highly ordered spacing of the nanorods may provide a mechanically robust and strong adhesion with the optical medium. In embodiments a thin film may be placed between the plurality of nanorods and the surface of the optical medium to promote adhesion without impairing the RI of optical paths through the optical medium.

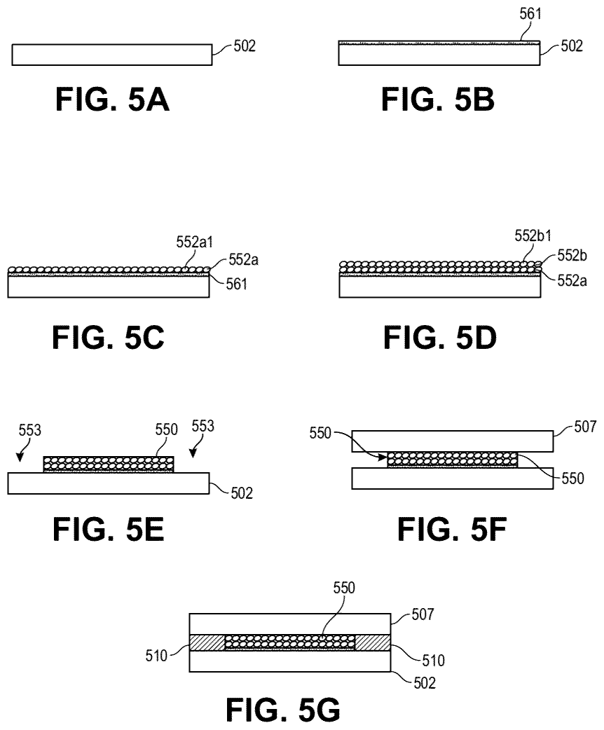

In embodiments, within a coating, layers of pluralities of nanorods may include titanium dioxide (TiO₂), SiO₂, or another material that may be deposited using OAD techniques. The result is a highly antireflective coating that significantly reduces Fresnel reflection that may result from a legacy aluminum nitrate (AlN) to air interface over a broad range of wavelengths. This is achieved by controlling the RI of the TiO₂ and SiO₂ nanorods layers, which may be bought down to a RI value of n=1.05 that closely matches the RI value of air (n=1.0) as seen in FIG. 6. In embodiments, the refractive index of low-n materials is low enough that the reflection or scattering may be neglected.

Embodiments described herein may facilitate applications over a broad wavelength range and over any profile, for example linear, cubic, or quantic morphology, that use optical mediums with RI that may span a range from air with an RI value of n=1.0 to a substrate material, for example glass, where an initial nanorod layer deposited on the substrate material should have an RI match, for example an RI value match at n=1.5.

In embodiments, the techniques described herein will enable extremely low RI materials that will significantly save the reflection loss budget at optical interfaces, as well as to enable robust, high-bandwidth, low-power optical data communication within photonic components in a photonic package. Embodiments of the coatings described herein may be flexibly tuned, including the orientation, size, and composition of the nanorods within layers of the coatings, that make the coatings applicable over a broad range of wavelengths. In addition, when the coating is used between two optical mediums, for example glass, the composition of the coating may be selected to enable reliable adhesion between the two optical mediums.

In the following detailed description, reference is made to the accompanying drawings which form a part hereof, wherein like numerals designate like parts throughout, and in which is shown by way of illustration embodiments in which the subject matter of the present disclosure may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use perspective-based descriptions such as top/bottom, in/out, over/under, and the like. Such descriptions are merely used to facilitate the discussion and are not intended to restrict the application of embodiments described herein to any particular orientation.

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

The term “coupled with,” along with its derivatives, may be used herein. “Coupled” may mean one or more of the following. “Coupled” may mean that two or more elements are in direct physical or electrical contact. However, “coupled” may also mean that two or more elements indirectly contact each other, but yet still cooperate or interact with each other, and may mean that one or more other elements are coupled or connected between the elements that are said to be coupled with each other. The term “directly coupled” may mean that two or more elements are in direct contact.

Various operations may be described as multiple discrete operations in turn, in a manner that is most helpful in understanding the claimed subject matter. However, the order of description should not be construed as to imply that these operations are necessarily order dependent.

As used herein, the term “module” may refer to, be part of, or include an ASIC, an electronic circuit, a processor (shared, dedicated, or group) and/or memory (shared, dedicated, or group) that execute one or more software or firmware programs, a combinational logic circuit, and/or other suitable components that provide the described functionality.

Various Figures herein may depict one or more layers of one or more package assemblies. The layers depicted herein are depicted as examples of relative positions of the layers of the different package assemblies. The layers are depicted for the purposes of explanation, and are not drawn to scale. Therefore, comparative sizes of layers should not be assumed from the Figures, and sizes, thicknesses, or dimensions may be assumed for some embodiments only where specifically indicated or discussed.

Various embodiments may include one or more articles of manufacture (e.g., non-transitory computer-readable media) having instructions, stored thereon, that when executed result in actions of any of the above-described embodiments. Moreover, some embodiments may include apparatuses or systems having any suitable means for carrying out the various operations of the above-described embodiments.

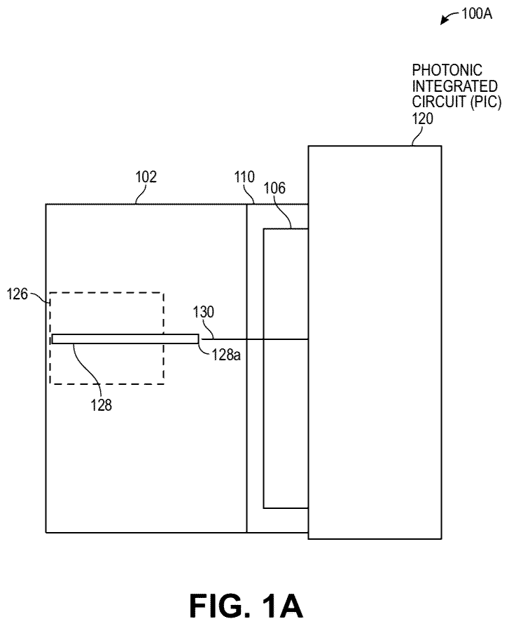

FIGS. 1A-1B illustrates cross section side views of portions of legacy photonics packages that include underfill separating two different optical mediums within an optical path. FIG. 1A is a cross section side view of a portion of a legacy photonics package 100A that has a first optical medium 102 that is optically coupled with a second optical medium 106 using an underfill 110. The first optical medium 102 and the second optical medium 106 may include glass. The underfill 110 provides mechanical stability between the first optical medium 102 and the second optical medium 106.

The second optical medium 106 may be optically coupled with a photonics integrated circuit (PIC) 120. An optical connector interface 126 may be coupled with or may be within the first optical medium 102, and may optically couple with a waveguide 128 that is used to conduct light 130. At the end of the waveguide 128a, light 130 may continue through the first optical medium 102, through the underfill 110, through the second optical medium 106, and to the PIC 120. In legacy implementations, the underfill 110 may include SiO₂ or AlN, and may be formed as a film. However, in these legacy implementations, the underfill 110 will typically have an RI value of n=1.5 or greater, which may cause a significant reduction in the reflection loss budget for the photonics package during operation.

FIG. 1B is a cross section side view of a portion of another legacy photonics package 100B includes a first optical medium 102, which may be a glass substrate, an optical connector interface 126 within or attached to the first optical medium 102, and a waveguide 128 optically coupled with the optical connector interface 126. Light 132, which may be similar to light 130 of FIG. 1A, is transmitted and/or received from an end of the waveguide 128 and travels to a first mirror 122. In implementations, the first mirror 122 may be a parabolic mirror, a flat mirror, or a mirror of some other shape. In implementations, the light 132 reflects off the first mirror 122 resulting in light 134 which extends out of the first optical medium 102 and through an underfill 110, and through the second optical medium 107, which may be similar to second optical medium 106 of FIG. 1A.

In implementations, light 134 will extend to a PIC 121, which may be similar to PIC 120 of FIG. 1A, which includes a second mirror 124, which may be similar to first mirror 122, that redirects light 134 to light 136. The light 136 then encounters the PIC 121. In implementations, the second mirror 124 may be secured to the PIC 121 using a support 125. In some implementations, the support 125 may include material that is similar to underfill 110.

In implementations, the first mirror 122 may be supported by a support structure 140, which in turn may be supported by a substrate 142 that may have anchor points 143. In implementations, the anchor points 143 may be coupled to another substrate (not shown). In implementations, the support structure 140 may include a fill material, for example, an underfill layer.

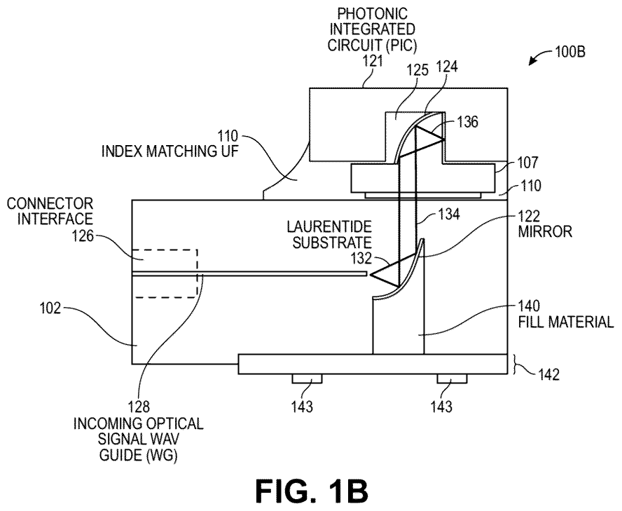

FIG. 2 illustrates a cross section side view and a top-down view of a portion of a photonics package that includes a nanorod coating between two different optical mediums within an optical path, in accordance with various embodiments. Photonics package portion 200A, which may be similar to photonics package portion 100B of FIG. 1B, includes a first optical medium 202, which may be a glass substrate, an optical connector interface 226 coupled with or within the first optical medium 202, and a waveguide 228 connected with the optical connector interface 226. Light 232, which may be similar to light 132 of FIG. 1B, may be transmitted and/or received from an end of the waveguide 228 and travels to a first mirror 222.

In embodiments, the light 232 may reflect off the first mirror 222 resulting in light 234 which extends out of the first optical medium 202 and through coating 250. In embodiments, the coating 250 may have a first side that is coupled with the first optical medium 202, and a second side opposite the first side that is coupled with the second optical medium 207. In embodiments, the first optical medium may include a selected one or more of: glass, silicon, carbon, nitrogen, SiCN, or SiNx.

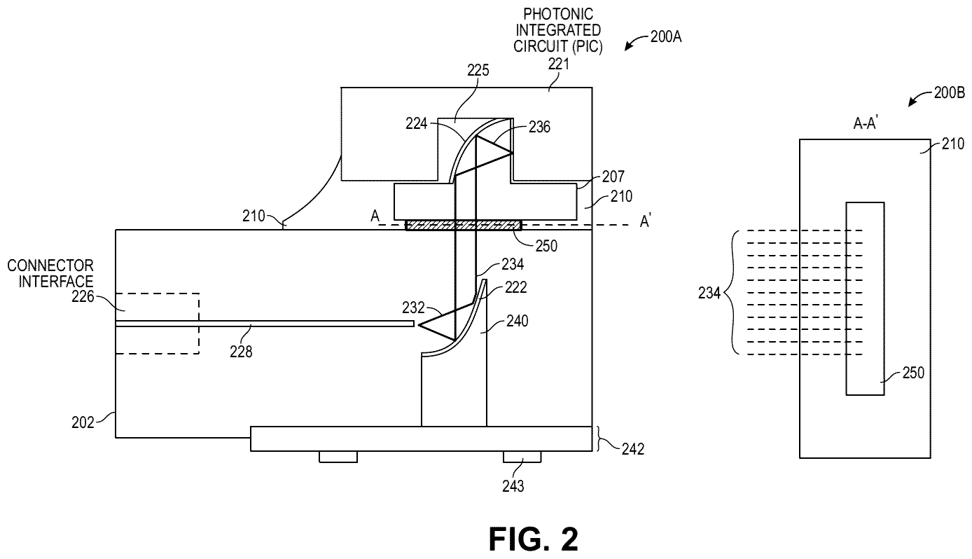

In embodiments, the coating 250 may be surrounded by underfill 210. In embodiments, the coating 250 and/or the underfill 210 may provide mechanical support and/or adhesive support for the first optical medium 202 and the second optical medium 207. In embodiments, the coating 250 may include nanorods as described further below with respect to FIG. 3. The light 234 then passes into the second optical medium 207. In embodiments, the second optical medium 207 may include glass, silicon, carbon, nitrogen, SiCN, SiNx, or air.

In embodiments, light 234 will extend within a PIC 221, which may be similar to PIC 121 of FIG. 1B, which may include a second mirror 224 that redirects light 234 to light 236. The light 236 then encounters the PIC 221. In embodiments, the second mirror 224 may be secured to the PIC 221 using a support 225. In some embodiments, the support 225 may include material that is similar to underfill 210. In embodiments, the first mirror 222 may be supported by a support structure 240, which may be supported by a substrate 242 that may have anchor points 243. In embodiments, the anchor points 243 may be coupled to a substrate (not shown). In embodiments, unlike light 134 that travels through underfill 110 of FIG. 1B, light 234 does not travel through underfill 210, but travels through the coating 250.

Diagram 200B shows a cross-section A-A′ of photonics package portion 200A where the coating 250 is surrounded by the underfill 210. As shown, the coating 250 has a rectangular shape; however, any shape may be used that accommodates the width of the light 234. In embodiments, depending upon the chemical composition of the coating 250, the amount of underfill 210 that surrounds the coating 250 may be increased or decreased to provide required mechanical stability and/or adhesion properties. In embodiments, the coating 250 may be conformally deposited onto the first optical medium 202, and a subtractive patterning process may be used to define a geometry of the coating 250 on the surface of the first optical medium 202.

FIG. 3 illustrates a cross section side view of layers of a nanorod coating between two different optical mediums within an optical path, in accordance with various embodiments. Coating 350, which may be similar to coating 250 of FIG. 2, may be on a surface of a first optical medium 302, which may be similar to first optical medium 202 of FIG. 2. The coating 350, which may be referred to as a graded-index coating, may include multiple nanorod layers 352, where each of the multiple nanorod layers 352 includes a plurality of nanorods 360.

In embodiments, there may be a film 361 between the surface of the first optical medium 302 and multiple nanorod layers 352. In embodiments, the film 361 which may include AlN, may be used to increase adhesion between the multiple nanorod layers 352 and the surface of the first optical medium 302. In embodiments, the film 361 may have a minimum thickness to provide adhesion but that does not significantly contribute additional reflection that would impact the reflection budget.

In embodiments, the multiple nanorod layers 352 may include one or more layers. As shown in FIG. 3, there are seven nanorod layers 352a-352g that are in a stacked formation. In embodiments, each of the plurality of nanorods 360 within a nanorod layer, for example nanorod 352c1 within nanorod layer 352c, generally has a similar size and a similar or a common orientation, which may also be referred to as a direction. As shown, nanorod 352c1 has an orientation that goes from upper left bottom right, as do the other nanorods within the nanorod layer 352c1. In embodiments, each of the nanorod layers 352a-352g contribute to reducing the overall RI that is experienced when light, such as light 234 of FIG. 2, passes through the coating 350. This is discussed further in FIG. 6.

In embodiments, the orientation of the nanorods in adjacent nanorod layers, for example nanorod layers 352a, 352b, or nanorod layers 352e, 352f, may have a common or a similar orientation with respect to a surface of the first optical medium 302 or with respect to a surface of the second optical medium 307. This common or similar orientation may be referred to as a tilt angle. In embodiments, an example of the tilt angle may include 45°. In some embodiments, the orientation of the nanorods in adjacent nanorod layers, for example nanorod layers 352d, 352e or nanorod layers 352f, 352g, may be in substantially different orientations.

In embodiments, the nanorods 360 may be oblique to the surface of the first optical medium 302. For example, an orientation of the nanorods 360 may be an orientation other than an orientation that is perpendicular 302a to the surface of the first optical medium 302. In embodiments, the orientation of a nanorod, for example nanorod 352e1 of nanorod layer 352e, may be to one side of the perpendicular 302a to the surface of the first optical medium 302, and the angle of an orientation of a nanorod in adjacent nanorod layer, for example nanorod 352d1 of nanorod layer 352d, may be to the other side of the perpendicular 302a.

In embodiments, adjacent nanorod layers, for example nanorod 352a1 of nanorod layer 352a, and nanorod 352b1 of nanorod layer 352b, may have similar orientations, however a size and/or length of the nanorod 352a1 and nanorod layer 352b1 may be different. In embodiments, if nanorod layer 352a first placed and nanorod layer 352b is placed on top of nanorod layer 352a, then nanorod 352b1 will have a larger size and/or length as compared to nanorod 352a1. In embodiments discussed below, this may be due to the OAD technique used to form the multiple nanorod layers 352.

In embodiments, after the coating 350 is formed on the surface of the first optical medium 302, a second optical medium 307, which may be similar to second optical medium 207 of FIG. 2, may be placed on the coating 350. In embodiments, a film (not shown, but which may be similar to film 361), may be placed on a surface of the second optical medium 307 to facilitate adhesion to the coating 350.

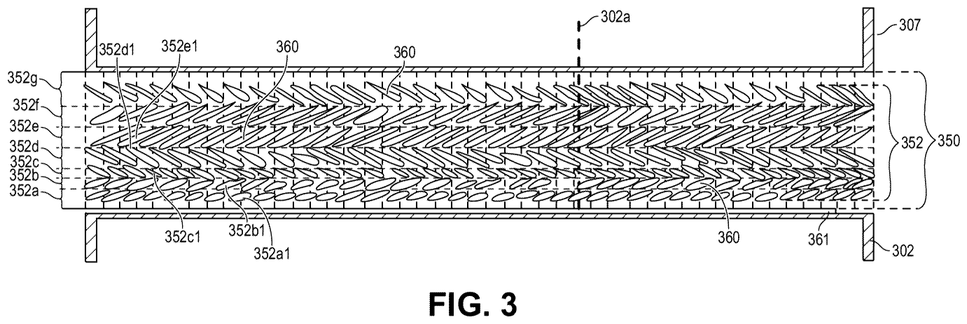

FIG. 4 illustrates diagrams of OAD techniques that may be used to apply one or more nanorod layers of a nanorod coating onto a surface of an optical medium, in accordance with various embodiments. Diagram 400 shows an example of an OAD technique that involves a vapor flux source 461 that is able to produce vapor flux 462 toward the surface of an optical medium 402, which may be similar to optical medium 302 of FIG. 3.

In embodiments, the vapor flux 462 may be used to create the nanorods 460 within a nanorod layer 452, which may be similar to nanorods 360 within a layer of the multiple nanorod layers 352 of FIG. 3, for example nanorod 352a1 within nanorod layer 352a of FIG. 3. In embodiments, different materials may be used within the vapor flux 462, for example, titanium, oxygen, silicon, nitrogen, TiO₂, SiO₂, SiNₓ, SiOₓN_{y}, TiNₓ, or any other type of thin films that can be stacked up independently with tunable tilt angles, tunable thickness, tunable columnar size, and tunable compositions which may include, for example, atomic species, stoichiometric ratio, and the like, using OAD techniques or any other technique to create nanorods 460.

In embodiments, the optical medium 402 may be rotated around an axis 403a, may be moved in a lateral direction 403b, or may be moved in a Z direction 403c. In embodiments, an orientation of a plurality of nanorods, for example nanorods 360 within nanorod layers 352 of FIG. 3, may be determined based on the orientation of the optical medium 402 and the intensity of the distribution of vapor flux 462. In embodiments, the orientation of a plurality of nanorods 460 may be referred to as a tilt angle.

Diagram 401 shows a cross section side view of an optical medium 402 with nanorods 460 being formed on a surface of the optical medium 402. In embodiments, a tilt angle β 470 for the nanorods 460, from a perpendicular 402a of the surface of the optical medium 402, may result as the vapor flux 462 is deposited at an angle α 472 with respect to the perpendicular 402a of the surface of the optical medium 402.

The OAD process produces nanorods 460 that are directional column whose structures that come about through the direct effect of atomic self-shadowing, resulting in shadow regions 474, during the vapor flux 462 deposition process. In embodiments, rotations of the optical medium 402 control a shape of the nanorods 460.

In embodiments, as evaporant of the vapor flux 462 nucleates on the surface of the optical medium 402, shadow regions 474 are formed as a result of a buildup of random, agglomerated nuclei or grains (not shown) on the nanorods 460 that cause the shadow regions 474 to not receive any additional vapor flux 462. As a result, shadowing effects lead to columnar nanorods 460 due to the limited adatom diffusion into shadow regions 474 where the boundaries or voids between the nanorods 460 cannot receive vapor flux 462.

In embodiments, as a result, nanorods 460 may be composed of approximately cylindrical columns of material, separated by voids. When the optical medium 402 is tilted such that vapor flux 462 arrives at increasingly oblique angles, the shadowing effect described above is enhanced, and additional material growth 460a is formed on the faces of the domed tops of the nanorods 460 facing the vapor flux source 461. As a result, the columnar nanostructure starts to become inclined toward the vapor flux source 461 along the direction of the vapor flux 462.

In embodiments, there may be a layer of film (not shown), which may include AlN and that may be similar to film 361 of FIG. 3 on the surface of the optical medium 402 prior to deposition of the nanorods 460. In addition, these OAD techniques may be used to form multiple nanorod layers, such as multiple nanorod layers 352 of FIG. 3, where each layer is grown up on a top of a previous layer.

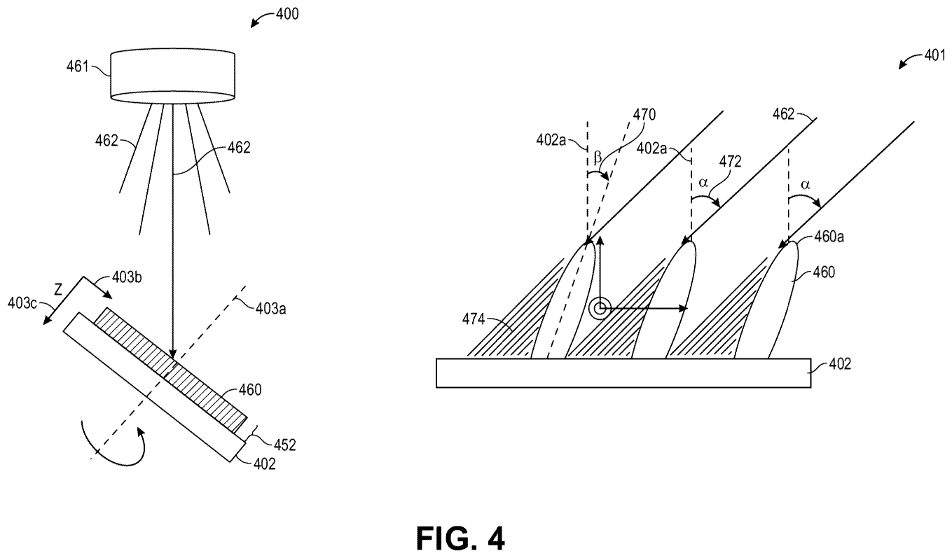

FIGS. 5A-5G illustrate various cross section side views of nanorod coatings in various stages of manufacture, in accordance with various embodiments. FIG. 5A illustrates a cross section side view of a stage in the manufacturing process where an optical medium 502, which may be similar to first optical medium 302 of FIG. 3 or optical medium 402 of FIG. 4, is provided. In embodiments, the optical medium 502 may include glass.

FIG. 5B illustrates a cross section side view of a stage in the manufacturing process where a film 561, which may be similar to film 361, is applied on the optical medium 502. In embodiments, the film 561 may be used to enhance adhesion between the optical medium 502 and the nanorod layers in subsequent stages of the manufacturing process. In embodiments, the film 561 may include AlN or SiO₂.

FIG. 5C illustrates a cross section side view of a stage in the manufacturing process where a first nanorod layer 552a of nanorods 552a1, which may be similar to nanorod layer 352a of nanorods 352a1 of FIG. 3, are placed on the film 561. In embodiments, the first nanorod layer 552a may be deposited using the OAD techniques described herein, in particular with respect to FIG. 4.

FIG. 5D illustrates a cross section side view of a stage in the manufacturing process where a second nanorod layer 552b of nanorods 552b1 may be placed on the first nanorod layer 552a using OAD techniques described herein. In embodiments, because the second nanorod layer 552b is deposited on the first nanorod layer 552a, the resulting structure of the individual nanorods 552b1 may be larger and/or longer than the individual nanorods 552a1. In embodiments, an orientation of each of the nanorods 552a1, 552b1 may be similar (as shown), or may be different. In subsequent stages, the stage represented in FIG. 5D may be repeated to achieve multiple nanorod layers.

FIG. 5E illustrates a cross section side view of a stage in the manufacturing process where a subtraction process may be used to etch voids 553 down to the optical medium 502 in order to define a shape of a coating 550, which may be similar to coating 250 of FIG. 2, on the surface of the optical medium 502.

FIG. 5F illustrates a cross section side view of a stage in the manufacturing process where a second optical medium 507, which may be similar to second optical medium 207 of FIG. 2, may be placed on the coating 550.

FIG. 5G illustrates a cross section side view of a stage in the manufacturing process where an underfill 510, which may be similar to underfill 210 of FIG. 2, may be placed around the coating 550 and between the optical medium 502 and the second optical medium 507. In embodiments, the underfill 510 may provide additional mechanical stability between the optical medium 502 and the second optical medium 507.

FIG. 6 shows an image of a cross section side view of a nanorod coating, in accordance with various embodiments. Image 600, which may be similar to coating 350 of FIG. 3, includes a film 661, which may be similar to film 361 of FIG. 3. Nanorod layers 652a-652e, which may be similar to nanorod layers 352a-352e of FIG. 3, are placed on top of each other. Individual nanorods 660 show various orientations and/or lengths depending upon the specific nanorod layer 652a-652e they are in.

As shown, nanorod layers 652a-652c were constructed using the OAD techniques described herein, using a TiO₂ material. Nanorod layers 652d-652e were constructed using the OAD techniques described herein using a SiO₂ material. An overall height of the nanorod layers 652a-652e is 0.7 μm. In embodiments, image 600 shows a modified-quintic profile.

Each of the nanorod layers 652a-652e contribute to a reduction to overall RI value. As shown, the first nanorod layer 652a has an RI value of approximately n=2.1. The second nanorod layer 652b reduces the total RI value to less than n=2.0. The third nanorod layer 652c reduces the total RI value to less than n=1.7. The fourth nanorod layer 652d reduces the total RI value to around n=1.3. The fifth nanorod layer 652e reduces the total RI value to around n=1.05. The number of layers can be tuned flexibility and may include any number of layers, depending on the type of film and initial substrate RI value.

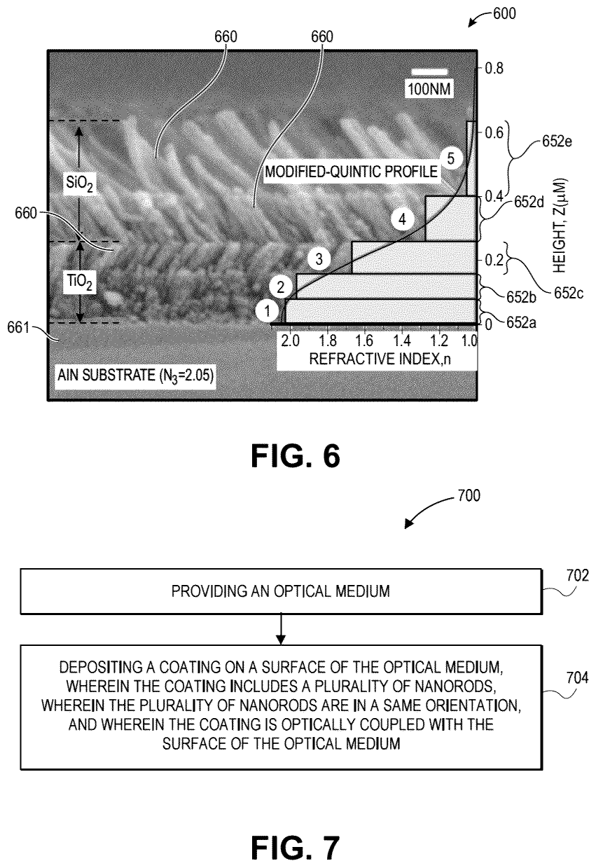

FIG. 7 illustrates an example of a process for manufacturing a portion of a package that includes depositing a nanorod coating on an optical medium, in accordance with various embodiments. Process 700 may be performed using the systems, apparatus, and processes, and/or techniques described herein, in particular with respect to FIGS. 1A-6.

At block 702, the process may include providing an optical medium. In embodiments, the optical media may be similar to first optical medium 202 of FIG. 2, first optical medium 302 of FIG. 3, first optical medium 402 of FIG. 4, or optical medium 502 of FIG. 5A.

At block 704, the process may further include depositing a coating on a surface of the optical medium, wherein the coating includes a plurality of nanorods, wherein the plurality of nanorods are in a same orientation, and wherein the coating is optically coupled with the surface of the optical medium. In embodiments, the coating may be similar to coating 250 of FIG. 2, 350 of FIG. 3, 550 of FIG. 5E, or nanorod layers 652a-652e of FIG. 6. In embodiments, the nanorods may be similar to nanorods 360 of FIG. 3, nanorods 460 of FIG. 4, nanorod 552a1 of FIG. 5C, nanorod 552b1 of FIG. 5D, or individual nanorods 660 of FIG. 6.

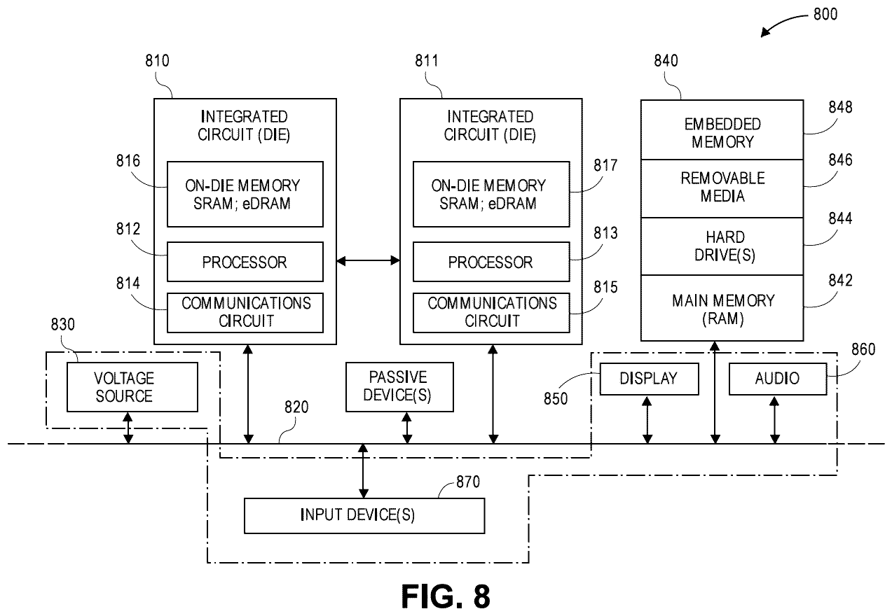

FIG. 8 is a schematic of a computer system 800, in accordance with an embodiment of the present invention. The computer system 800 (also referred to as the electronic system 800) as depicted can embody a nanorod coating between two optical mediums, according to any of the several disclosed embodiments and their equivalents as set forth in this disclosure. The computer system 800 may be a mobile device such as a netbook computer. The computer system 800 may be a mobile device such as a wireless smart phone. The computer system 800 may be a desktop computer. The computer system 800 may be a hand-held reader. The computer system 800 may be a server system. The computer system 800 may be a supercomputer or high-performance computing system.

In an embodiment, the electronic system 800 is a computer system that includes a system bus 820 to electrically couple the various components of the electronic system 800. The system bus 820 is a single bus or any combination of busses according to various embodiments. The electronic system 800 includes a voltage source 830 that provides power to the integrated circuit 810. In some embodiments, the voltage source 830 supplies current to the integrated circuit 810 through the system bus 820.

The integrated circuit 810 is electrically coupled to the system bus 820 and includes any circuit, or combination of circuits according to an embodiment. In an embodiment, the integrated circuit 810 includes a processor 812 that can be of any type. As used herein, the processor 812 may mean any type of circuit such as, but not limited to, a microprocessor, a microcontroller, a graphics processor, a digital signal processor, or another processor. In an embodiment, the processor 812 includes, or is coupled with, a nanorod coating between two optical mediums, as disclosed herein. In an embodiment, SRAM embodiments are found in memory caches of the processor. Other types of circuits that can be included in the integrated circuit 810 are a custom circuit or an application-specific integrated circuit (ASIC), such as a communications circuit 814 for use in wireless devices such as cellular telephones, smart phones, pagers, portable computers, two-way radios, and similar electronic systems, or a communications circuit for servers. In an embodiment, the integrated circuit 810 includes on-die memory 816 such as static random-access memory (SRAM). In an embodiment, the integrated circuit 810 includes embedded on-die memory 816 such as embedded dynamic random-access memory (eDRAM).

In an embodiment, the integrated circuit 810 is complemented with a subsequent integrated circuit 811. Useful embodiments include a dual processor 813 and a dual communications circuit 815 and dual on-die memory 817 such as SRAM. In an embodiment, the dual integrated circuit 810 includes embedded on-die memory 817 such as eDRAM.

In an embodiment, the electronic system 800 also includes an external memory 840 that in turn may include one or more memory elements suitable to the particular application, such as a main memory 842 in the form of RAM, one or more hard drives 844, and/or one or more drives that handle removable media 846, such as diskettes, compact disks (CDs), digital variable disks (DVDs), flash memory drives, and other removable media known in the art. The external memory 840 may also be embedded memory 848 such as the first die in a die stack, according to an embodiment.

In an embodiment, the electronic system 800 also includes a display device 850, an audio output 860. In an embodiment, the electronic system 800 includes an input device such as a controller 870 that may be a keyboard, mouse, trackball, game controller, microphone, voice-recognition device, or any other input device that inputs information into the electronic system 800. In an embodiment, an input device 870 is a camera. In an embodiment, an input device 870 is a digital sound recorder. In an embodiment, an input device 870 is a camera and a digital sound recorder.

As shown herein, the integrated circuit 810 can be implemented in a number of different embodiments, including a package substrate having a nanorod coating between two optical mediums, according to any of the several disclosed embodiments and their equivalents, an electronic system, a computer system, one or more methods of fabricating an integrated circuit, and one or more methods of fabricating an electronic assembly that includes a package substrate having a nanorod coating between two optical mediums, according to any of the several disclosed embodiments as set forth herein in the various embodiments and their art-recognized equivalents. The elements, materials, geometries, dimensions, and sequence of operations can all be varied to suit particular I/O coupling requirements including array contact count, array contact configuration for a microelectronic die embedded in a processor mounting substrate according to any of the several disclosed package substrates having a nanorod coating between two optical mediums embodiments and their equivalents. A foundation substrate may be included, as represented by the dashed line of FIG. 8. Passive devices may also be included, as is also depicted in FIG. 8.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

Various embodiments may include any suitable combination of the above-described embodiments including alternative (or) embodiments of embodiments that are described in conjunctive form (and) above (e.g., the “and” may be “and/or”). Furthermore, some embodiments may include one or more articles of manufacture (e.g., non-transitory computer-readable media) having instructions, stored thereon, that when executed result in actions of any of the above-described embodiments. Moreover, some embodiments may include apparatuses or systems having any suitable means for carrying out the various operations of the above-described embodiments.

The above description of illustrated embodiments, including what is described in the Abstract, is not intended to be exhaustive or to limit embodiments to the precise forms disclosed. While specific embodiments are described herein for illustrative purposes, various equivalent modifications are possible within the scope of the embodiments, as those skilled in the relevant art will recognize.

These modifications may be made to the embodiments in light of the above detailed description. The terms used in the following claims should not be construed to limit the embodiments to the specific implementations disclosed in the specification and the claims. Rather, the scope of the invention is to be determined entirely by the following claims, which are to be construed in accordance with established doctrines of claim interpretation.

### EXAMPLES

The following paragraphs describe examples of various embodiments.

Example 1 is an apparatus comprising: a first optical medium; a second optical medium; a coating that has a first side and a second side opposite the first side, wherein the first side of the coating optically couples with a surface of the first optical medium, and wherein the second side of the coating is proximate to the second optical medium; and wherein the coating includes a plurality of nanorods with a similar orientation with respect to the surface of the first optical medium.

Example 2 includes the apparatus of example 1, wherein the coating further includes a layer that includes at least some of the plurality of nanorods.

Example 3 includes the apparatus of example 2, wherein the at least some of the plurality of nanorods of the layer include a selected one or more of: titanium, oxygen, silicon, nitrogen, TiO₂, SiO₂, SiNₓ, SiOₓN_{y}, or TiNₓ.

Example 4 includes the apparatus of examples 2 or 3, wherein the similar orientation is oblique to the surface of the first optical medium.

Example 5 includes the apparatus of examples 2, 3, or 4, wherein the coating further includes a film, wherein the film is optically coupled with the at least a portion of the surface of the first optical medium, and wherein the film is optically coupled with the layer.

Example 6 includes the apparatus of example 5, wherein the film includes a selected one or more of: aluminum or nitrogen.

Example 7 includes the apparatus of examples 2, 3, 4, 5, or 6, wherein the similar orientation is a first similar orientation, wherein the layer is a first layer, and further comprising a second layer optically coupled with the first layer, wherein the second layer includes some of the plurality of nanorods, wherein the some of the plurality of nanorods have a second similar orientation, and wherein the second similar orientation is oblique to the surface of the first optical medium.

Example 8 includes the apparatus of example 7, wherein the first similar orientation and the similar same orientation are different orientations.

Example 9 includes the apparatus of examples 7 or 8, wherein the some of the plurality of nanorods of the second layer include a selected one or more of: titanium, oxygen, silicon, nitrogen, TiO₂, SiO₂, SiNₓ, SiOₓN_{y}, or TiNₓ.

Example 10 includes the apparatus of examples 2, 3, 4, 5, 6, 7, 8, or 9, wherein the first optical medium includes a selected one or more of: glass, silicon, carbon, nitrogen, SiCN, or SiNₓ.

Example 11 includes the apparatus of examples, 3, 4, 5, 6, 7, 8, 9, or 10, wherein the second optical medium includes a selected one or more of: glass, silicon, carbon, nitrogen, SiCN, SiNₓ, or air.

Example 12 includes the apparatus of examples 1, 2, 3, 4, 5, 6, 7, 8, 9, 10 or 11, wherein the second side of the coating is optically coupled with the surface of the second optical medium.

Example 13 includes the apparatus of examples 1, 2, 3, 4, 5, 6, 7, 8, 9, 10, 11 or 12, wherein the coating is conformally deposited on the surface of the first optical medium.

Example 14 is a package comprising: an optical waveguide; a first optical medium directly optically coupled with the optical waveguide; a coating directly optically coupled with a surface of the first optical medium, wherein the coating includes a plurality of nanorods; a second optical medium, wherein a surface of the second optical medium is directly optically coupled with the coating, and wherein the coating optically couples the first optical medium with the second optical medium; and a photonics integrated circuit (PIC) optically coupled with the second optical medium.

Example 15 includes the package of example 14, wherein at least some of the plurality of nanorods are in a common orientation, and wherein the common orientation is oblique to the surface of the first optical medium and oblique to the surface of the second optical medium.

Example 16 includes the package of examples 14 or 15, wherein the plurality of nanorods include a selected one or more of: titanium, oxygen, silicon, nitrogen, TiO₂, SiO₂, SiNₓ, SiOₓN_{y}, or TiNₓ.

Example 17 includes the package of examples 14, 15, or 16, further comprising a mirror between the second optical medium and the PIC.

Example 18 includes the package of examples 14, 15, 16, or 17, wherein the optical waveguide is a plurality of optical waveguides.

Example 19 includes the package of examples 14, 15, 16, 17, or 18, wherein the first optical medium has a first refractive index value, wherein the second optical medium has a second refractive index value, and wherein the first refractive index value is different than the second refractive index value.

Example 20 includes the package of examples 14, 15, 16, 17, 18, or 19, wherein the plurality of nanorods within the coating is a first plurality of nanorods; and further comprising: a second plurality of nanorods on the first plurality of nanorods, wherein a common orientation with respect to the surface of the first optical medium of the first plurality of nanorods is different than a common orientation with respect to the surface of the first optical medium of the second plurality of nanorods.

Example 21 includes the package of examples 14, 15, 16, 17, 18, 19, or 20, wherein the first optical medium or the second optical medium includes a selected one or more of: glass, silicon, carbon, nitrogen, SiCN, or SiNₓ.

Example 22 includes the package of examples 14, 15, 16, 17, 18, 19, 20, or 21, further comprising an underfill between the first optical medium and the second optical medium, wherein the underfill is directly coupled with the first optical medium and the second optical medium.

Example 23 is a method comprising: providing an optical medium; and depositing a coating on a surface of the optical medium, wherein the coating includes a plurality of nanorods, wherein the plurality of nanorods are in a similar orientation with respect to the surface of the optical medium, and wherein the coating is optically coupled with the surface of the optical medium.

Example 24 includes the method of example 23, wherein the optical medium is a first optical medium; and further comprising: providing a second optical medium; and coupling a surface of the second optical medium to the coating, wherein the first optical medium, the second optical medium, and the coating are optically coupled with each other.

Example 25 includes the method of examples 23 or 24, wherein depositing the coating on the surface of the optical medium further includes depositing the coating on the surface of the optical medium using oblique-angle deposition.

What is claimed is:

1. An apparatus comprising:
a first optical medium;
a second optical medium;
a coating that has a first side and a second side opposite the first side, wherein the first side of the coating optically couples with a surface of the first optical medium, and wherein the second side of the coating is proximate to the second optical medium; and
wherein the coating includes a plurality of nanorods with a similar orientation with respect to the surface of the first optical medium.

2. The apparatus of claim 1, wherein the coating further includes a layer that includes at least some of the plurality of nanorods.

3. The apparatus of claim 2, wherein the at least some of the plurality of nanorods of the layer include a selected one or more of: titanium, oxygen, silicon, nitrogen, TiO₂, SiO₂, SiNₓ, SiOₓN_{y}, or TiNₓ.

4. The apparatus of claim 2, wherein the similar orientation is oblique to the surface of the first optical medium.

5. The apparatus of claim 2, wherein the coating further includes a film, wherein the film is optically coupled with the at least a portion of the surface of the first optical medium, and wherein the film is optically coupled with the layer.

6. The apparatus of claim 5, wherein the film includes a selected one or more of: aluminum or nitrogen.

7. The apparatus of claim 2, wherein the similar orientation is a first similar orientation, wherein the layer is a first layer, and further comprising a second layer optically coupled with the first layer, wherein the second layer includes some of the plurality of nanorods, wherein the some of the plurality of nanorods have a second similar orientation, and wherein the second similar orientation is oblique to the surface of the first optical medium.

8. The apparatus of claim 7, wherein the first similar orientation and the second similar orientation are a different orientations.

9. The apparatus of claim 7, wherein the some of the plurality of nanorods of the second layer include a selected one or more of: titanium, oxygen, silicon, nitrogen, TiO₂, SiO₂, SiNₓ, SiOₓN_{y}, or TiNₓ.

10. The apparatus of claim 2, wherein the first optical medium includes a selected one or more of: glass, silicon, carbon, nitrogen, SiCN, or SiNₓ.

11. The apparatus of claim 2, wherein the second optical medium includes a selected one or more of: glass, silicon, carbon, nitrogen, SiCN, SiNₓ, or air.

12. The apparatus of claim 1, wherein the second side of the coating is optically coupled with the surface of the second optical medium.

13. The apparatus of claim 1, wherein the coating is conformally deposited on the surface of the first optical medium.

14. A package comprising:
an optical waveguide;
a first optical medium directly optically coupled with the optical waveguide;
a coating directly optically coupled with a surface of the first optical medium, wherein the coating includes a plurality of nanorods;
a second optical medium, wherein a surface of the second optical medium is directly optically coupled with the coating, and wherein the coating optically couples the first optical medium with the second optical medium; and
a photonics integrated circuit (PIC) optically coupled with the second optical medium.

15. The package of claim 14, wherein at least some of the plurality of nanorods are in a common orientation, and wherein the common orientation is oblique to the surface of the first optical medium and oblique to the surface of the second optical medium.

16. The package of claim 14, wherein the plurality of nanorods include a selected one or more of: titanium, oxygen, silicon, nitrogen, TiO₂, SiO₂, SiNₓ, SiOₓN_{y}, or TiNₓ.

17. The package of claim 14, further comprising a mirror between the second optical medium and the PIC.

18. The package of claim 14, wherein the optical waveguide is a plurality of optical waveguides.

19. The package of claim 14, wherein the first optical medium has a first refractive index value, wherein the second optical medium has a second refractive index value, and wherein the first refractive index value is different than the second refractive index value.

20. The package of claim 14, wherein the plurality of nanorods within the coating is a first plurality of nanorods; and further comprising: a second plurality of nanorods on the first plurality of nanorods, wherein a common orientation with respect to the surface of the first optical medium of the first plurality of nanorods is different than a common orientation with respect to the surface of the first optical medium of the second plurality of nanorods.

21. The package of claim 14, wherein the first optical medium or the second optical medium includes a selected one or more of: glass, silicon, carbon, nitrogen, SiCN, or SiNₓ.

22. The package of claim 14, further comprising an underfill between the first optical medium and the second optical medium, wherein the underfill is directly coupled with the first optical medium and the second optical medium.

23. A method comprising:
providing an optical medium; and
depositing a coating on a surface of the optical medium, wherein the coating includes a plurality of nanorods, wherein the plurality of nanorods are in a similar orientation with respect to the surface of the optical medium, and wherein the coating is optically coupled with the surface of the optical medium.

24. The method of claim 23, wherein the optical medium is a first optical medium; and further comprising:
providing a second optical medium; and
coupling a surface of the second optical medium to the coating, wherein the first optical medium, the second optical medium, and the coating are optically coupled with each other.

25. The method of claim 23, wherein depositing the coating on the surface of the optical medium further includes depositing the coating on the surface of the optical medium using oblique-angle deposition.
